(19) United States
(12) Patent Application Publication
(10) Pub. No.: US 2018/0008937 A1
(43) Pub. Date: Jan. 11, 2018

(54) COMPOSITE MOLECULAR SIEVE MEMBRANE, PREPARATION PROCESS AND USE THEREOF

(71) Applicants: Peking University Shenzhen Graduate School, Shenzhen City (CN); Hong Kong University of Science and Technology, Hong Kong (CN)

(72) Inventors: MEI HONG, SHENZHEN CITY (CN); DONG LV, HONG KONG (CN); ZHUWEN CHEN, SHENZHEN CITY (CN); JIAYING ZENG, HONG KONG (CN); JINGSHEN WU, HONG KONG (CN); JIAN ZHANG, SHENZHEN CITY (CN); SHAN BAI, SHENZHEN CITY (CN)

(21) Appl. No.: 15/426,232

(22) Filed: Feb. 7, 2017

Related U.S. Application Data
(60) Provisional application No. 62/493,527, filed on Jul. 8, 2016.

(30) Foreign Application Priority Data
Aug. 15, 2016 (CN) 2016 1067 1438.1

(51) Int. Cl. B01D 71/02; B01D 69/12

(52) U.S. Cl. CPC B01D 71/028; B01D 71/025; B01D 71/027; B01D 69/125; B01D 2323/12; B01D 2323/14; B01D 2323/08

(57) ABSTRACT

A composite molecular sieve membrane, preparation method and use thereof are provided in the embodiments. The composite molecular sieve membrane includes a support layer and a molecular sieve membrane layer, wherein the support layer is a high-porosity and porous ceramic which is made of nano- or submicron ceramic powder materials or ceramic material precursors prepared through an electrospinning process. The high-porosity and porous ceramic, is adjustable from 40% to 83%. The composite molecular sieve membrane of the embodiments uses the porous ceramic prepared through an electrospinning process as the support layer, and the support layer has a flat and continuous surface, high porosity, uniform and adjustable pore sizes, low-tortuosity pore channels, and high mechanical strength; the flux of the composite molecular sieve membrane is increased, besides, the seed crystals can attach effectively due to the fibrous pore channels of the support layer, ensuring the adhesion amount of seed crystals.

### CROSS-REFERENCE TO RELATED APPLICATIONS

This application claims priority to CN 201610671438.1, having a filing date of Aug. 15, 2016 and U.S. Provisional Application No. 62/493,527 having a filing date of Jul. 8, 2016, the entire contents of which are hereby incorporated by reference.

### FIELD OF TECHNOLOGY

The following relates to the field of molecular sieve membranes, particularly to a composite molecular sieve membrane, preparation process and use thereof.

### BACKGROUND

The molecular sieve membrane has attracted much attention in aspect of high-efficient and economical separation applications, and moreover, the molecular sieve membrane is widely used in the fields of sensors, biological medicine, antirot materials, dielectric materials, microreactors and the like. The molecular sieve membrane is a new inorganic membrane material having an effective pore size in the range of micromolecular dimension, and being capable of sieving molecules. The molecular sieve membrane has incomparable advantages, for example, (1) the molecular sieve membrane has uniform pore sizes, e.g., the conventional micropore zeolite has an adjustable pore size in a range between 0.3 to 1.9 nm, which approaches to the general molecular size, thus molecules with different sizes can be sifted out according to the pore sizes of molecular sieves; besides, the new mesoporous molecular sieve has an adjustable pore size in a range between 2 to 50 nm; (2) the molecular sieve has an adjustable element composition such as the silicon/aluminum ratio, and an adjustable hydrophilic/hydrophobic property; the free cations can be exchanged, so as to control the coulomb field, whereby the molecules having similar size but different polarities or degrees of polarization can be absorbed and infiltrated selectively; (3) the molecular sieve has catalytic activity and can be used as a membrane reactor material; in addition, as an inorganic membrane, the molecular sieve is chemically stable, heat-resistant and back-flush available, and it has a high mechanical strength, an excellent antimicrobial capability, a long lifetime, a narrow pore size distribution, a high separation efficiency and so on.

So far, it is well known that there are more than 200 types of the narrowly defined molecular sieves, i.e., zeolite material, and the generalized molecular sieves cover broader scope, such as mesoporous silica, mesoporous zeolite, and the like. However, it is reported that only 20 types of continuous and effective molecular sieve separating membranes have been developed, and one of the main reasons is the unsuitability and incompatibility between the molecular sieve membranes and the supports. The molecular sieve separating membrane in industrial use usually consists of three parts: 1) porous support, such as the aluminum oxide, zirconium oxide, mullite, stainless steel, glass, and the like; 2) transition layer; 3) polycrystalline effective separating layer of molecular sieve. The porous support is significant for the molecular sieve membrane, because the support increases the mechanical strength of the integral structure, and the macroporous structure of the support acts as a buffer in the separating application, to decrease the transmission resistance, which is capable of protecting the molecular sieve membrane effectively. In addition, the separation flux of the molecular sieve membrane is linearly associated with the porosity of the support, and the higher the porosity, the larger the separation flux. Further, the cost of the support plays an important part in the price of the molecular sieve membrane, which is also one of the reasons to cause the high price of the molecular sieve membrane nowadays. The support should have uniform pore sizes, a large flux and a high porosity. Most commercially available supports are aluminium oxide supports made of aluminium oxide fine powders through slip casting and subsequent sintering process. Such aluminium oxide ceramic support prepared through the slip casting of microparticles and calcinations has pores mainly formed by gaps between the particles. Therefore, the porosity is generally low, e.g., in a range between 30% and 40%, which highly restricts the increases of fluxes of the support and the composite molecular sieve membrane. More importantly, it is difficult for the growth of molecular sieve membrane and the coating of seed crystals due to the low porosity of the commercially available ceramic support and the non-uniform pore size distribution in its surface, and the obviously incontinuous molecular sieve layer can be found at the flat area on the surface of ceramic support. Oversized cavities in the surface will make the seed crystal fall off before the later membrane formation, and undersized or too narrow cavities in the surface is detrimental to the attachment of seed crystals. Therefore, the research on a new support is a key point to improve the overall properties of the molecular sieve membrane.

### SUMMARY

An aspect relates to a new composite molecular sieve membrane, preparation and use thereof.

The following provides the following technical solution.

In one aspect, the present embodiments of the invention provide a composite molecular sieve membrane, comprising a support layer and a molecular sieve membrane layer, wherein the support layer is a high-porosity and porous ceramic which is made of ceramic powders or ceramic precursor prepared through electrospinning process; the ceramic powders have particle sizes in a range between 1 nm and 500 nm; the high-porosity and porous ceramic has a porosity of up to 83%, and the porosity is adjustable from 40% to 83%; the porous ceramic has a pore size in a range between 0.1 and 10 μm, and the tortuosity of pore channel is less than 2.

It should be noted that the key point for the present invention is that a high-porosity and porous ceramic prepared through electrospinning process is taken as the support layer. The composite molecular sieve membrane of the present invention comprises a support layer having a porosity which is adjustable in a range between 40%-83%. The support layer of the present invention having a porosity of up to 83% increases the flux of composite molecular sieve membrane greatly, compared with the conventional support layers. It should be understood that the key point for the present invention is that the electrospinning process is applied to prepare the porous ceramic support layer of the composite molecular sieve membrane. With regarding to the specific materials of which the porous ceramic is made, conventional ceramic materials or precursors can be used; the molecular sieve membrane layer may also be conventional, not specifically defined here. However, in order to achieve preferable effects, the ceramic materials and the preparation methods of molecular sieve membrane layer will be specially defined in the preferable technical solutions of the present invention, and these will be explained in detail in subsequent technical solutions.

Preferably, the support layer has a thickness in a range between 0.1 and 5 mm. More preferably, the support layer has a thickness in a range between 2 and 5 mm.

Preferably, the ceramic powder may be one or more selected from a group consisting of halloysite nanotubes, titanium dioxide, aluminum oxide, zirconium oxide, ferric oxide, yttrium oxide, zinc oxide, silicon carbide, silicon nitride, nickel oxide, manganese oxide, perovskite and uhligite.

Preferably, a continuously distributed molecular sieve membrane layer is formed on the surface of the support layer through at least one of the methods of secondary growth, in-situ hydrothermal synthesis and vapor-phase transport (VPT).

In another aspect of the present invention, the use of composite molecular sieve membrane of the present invention in membrane separation, sensors, biomedicine, antirot materials, dielectric materials or microreactors is disclosed.

It should be understood that in the composite molecular sieve membrane of the embodiments of the present invention, high-porosity and porous ceramic support layer prepared through electrospinning process increases the flux of the composite molecular sieve membrane largely, and it also has a fibrous pore channel structure which easily match with molecular sieve crystals having different sizes, so as to facilitate the coating of seed crystals and the growth of molecular sieve membrane layer at the support layer. The coated seed crystals or synthesized molecular sieve crystals are embedded in cavities of the support layer, which guarantees the stability of seed crystals in the support layer, and thereby the performance of the composite molecular sieve membrane is improved. It could be seen that the composite molecular sieve membrane of the present invention actually acts as an improved composite molecular sieve membrane with bigger flux of molecular sieve and better stability compared with the existing molecular sieve, when the composite molecular sieve membrane is used as a membrane separation material. Therefore, with regarding to those fields comprising but not limited to the fields of sensors, biological medicine, antirot materials, dielectric materials, and microreactors, in which the existing molecular sieve applies, the composite molecular sieve membrane of the embodiments of the present invention can also apply.

A further aspect of the embodiments of the present invention discloses a preparation method of the composite molecular sieve membrane embodiments of the of the present invention, which comprises the following steps:
(1) dispersing the nano- or submicron ceramic powder material or ceramic material precursor in a solvent, then adding a polymer and stirring them evenly to obtain a spinning solution used for electrospinning process;
(2) applying an electrospinning method to obtain a ceramic material/polymer composite fiber membrane with the spinning solution;
(3) pretreating the ceramic material/polymer composite fiber membrane, and press-forming it afterwards;
(4) sintering the press-formed composite fiber membrane to remove the polymer, whereby a support layer is prepared;
(5) applying at least one of the methods of the secondary growth, in-situ hydrothermal synthesis and vapor-phase transport to form a continuously distributed molecular sieve membrane layer on the surface of the support layer, whereby a composite molecular sieve membrane is prepared;
wherein the polymer is at least one selected from a group consisting of polystyrene (PS), polyacrylonitrile (PAN), polyvinylpyrrolidone (PVP), poly(lactic-co-glycolic acid) (PLGA), polyvinyl alcohol (PVA), polyethylene oxide (PEO), polyamide (PA), polyvinylidene fluoride (PVDF), polyvinyl butyral (PVB), polyimide (PI), cellulose acetate (CA), polymethyl methacrylate (PMMA), poly(L-lactic acid) (PLLA) and polyethylene terephthalate (PET); the polymer has a molecular weight in a range between 0.1 million and 0.5 million; the pretreatment comprises a pre-oxidization carried out under a temperature between 70 and 280° C. in air atmosphere for less than 48 hours.

It should be noted that the pre-oxidization of the embodiments of the present invention refers to a heating treatment in the air atmosphere, and it is for the purpose of cross-linking reaction of polymers.

Preferably, in the preparation method of the embodiments of the present invention, the weight ratio of the solvent and polymer is from 4:1 to 19:1; and the weight ratio of ceramic powder material or ceramic material precursor and polymer is between 1:10 to 1:0.

Preferably, in the preparation method of the embodiments of the present invention, the ratio of silicon and aluminum in the molecular membrane layer is in a range from 1 to infinity, or the molecular membrane layer is heteroatom-substituted, and the heteroatom-substituted molecular sieve comprises, but not limited to, SAPO-34, AlPO-18 or TS-1.

Among them, the SAPO-34 is substituted by S and P, AlPO-18 is substituted by P, TS-1 is substituted by Ti.

Preferably, in the preparation method of the embodiments of the present invention, the solvent in step (1) is at least one selected from a group consisting of water, tetrahydrofuran (THF), N,N-dimethylformamide (DMF), N,N-dimethylacetamide (DMAC), acetone, ethanol (EtOH), methanol (MeOH).

The embodiments of the present invention has beneficial effects that the composite molecular sieve membrane of the embodiments of the present invention applies porous ceramics prepared by the electrospinning process as the support layer, and the support layer has a flat and continuous surface, high porosity, uniform and adjustable pore size, low-tortuosity pore channels, and high mechanical strength; the flux of the composite molecular sieve membrane is increased, besides, the seed crystals can attach effectively due to the fibrous pore channels of the support layer, ensuring the adhesion amount of seed crystals; further the molecular sieve membrane layer and support layer are greatly matched and compatible, and the stability of the molecular sieve membrane layer is improved.

### BRIEF DESCRIPTION

Some of the embodiments will be described in detail, with reference to the following figures, wherein like designations denote like members, wherein:

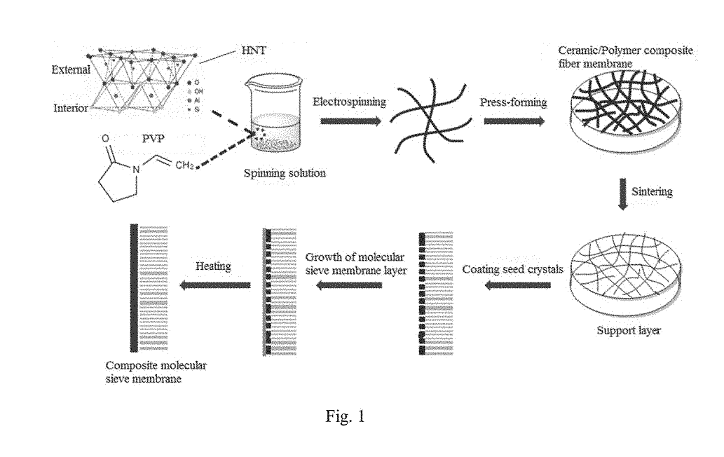

FIG. 1 is a flow diagram of the preparation of the composite molecular sieve membrane according to the example of embodiments of the present invention;

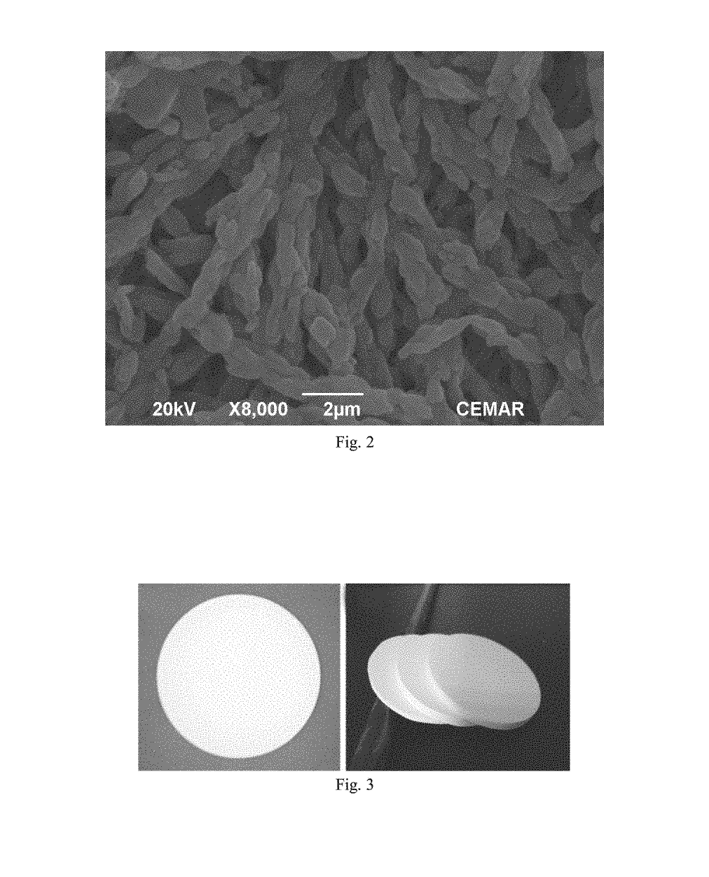

FIG. 2 is a SEM micrograph of the surface of the high-porosity and porous ceramic support layer prepared according to Example 1 of embodiments of the present invention;

FIG. 3 is a schematic diagram of the high-porosity and porous ceramic support layer prepared according to Example 2 of embodiments of the present invention;

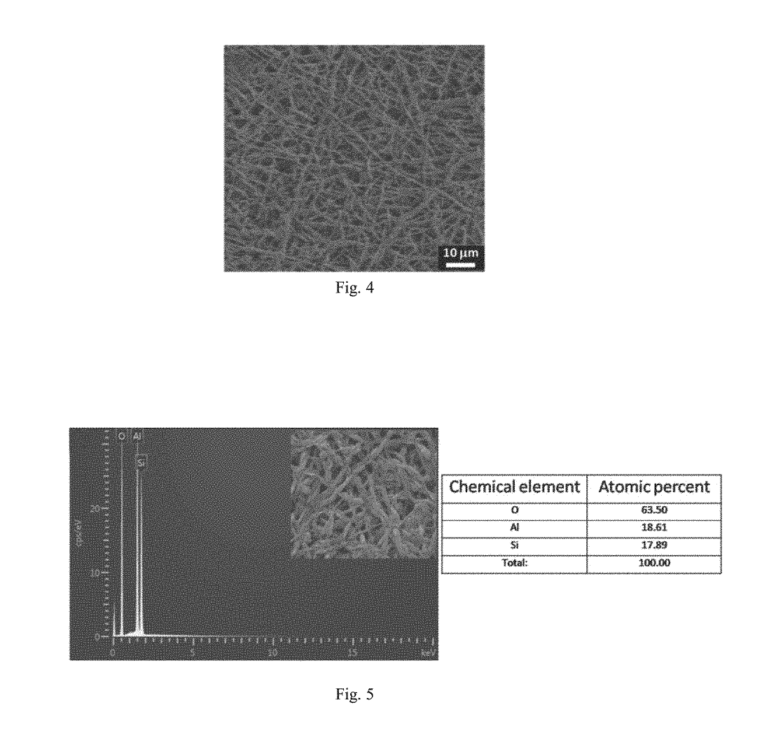

FIG. 4 is a SEM micrograph of the surface of the high-porosity and porous ceramic support layer prepared according to Example 2 of embodiments of the present invention;

FIG. 5 is a diagram showing micro SEM-EDX element analysis of the high-porosity and porous ceramic support layer prepared according to Example 2 of embodiments of the present invention;

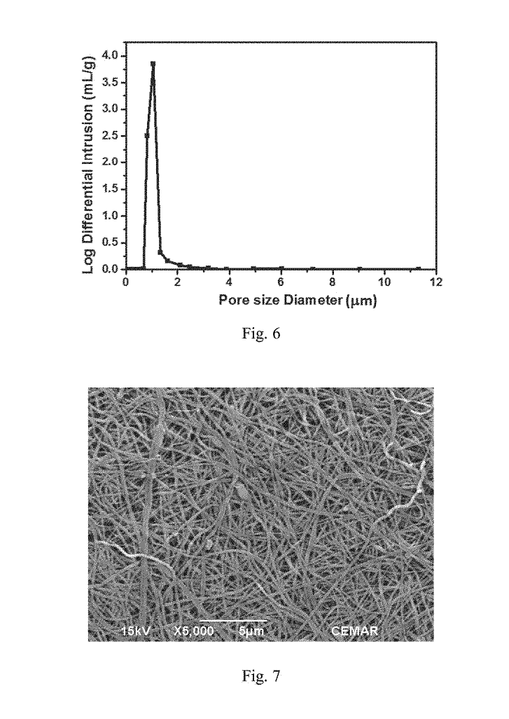

FIG. 6 is a diagram showing a pore size distribution of the high-porosity and porous ceramic support layer prepared according to Example 2 of embodiments of the present invention;

FIG. 7 is a SEM micrograph of the surface of the high-porosity and porous ceramic support layer prepared according to Example 3 of embodiments of the present invention;

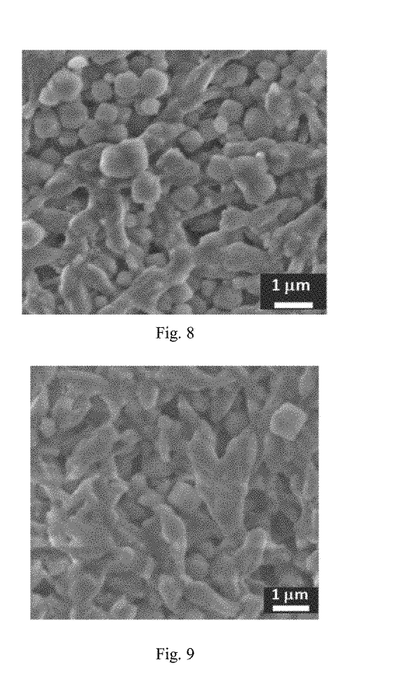

FIG. 8 is a SEM micrograph of the surface of the support layer coated with seed crystals for LTA (NaA) molecular sieve synthesized according to Example 4 of embodiments of the present invention;

FIG. 9 is a SEM micrograph of the surface of the support layer coated with seed crystals for LTA (NaA) molecular sieve synthesized according to the Example 4 of embodiments of the present invention, after being ultrasonically treated for 2 minutes;

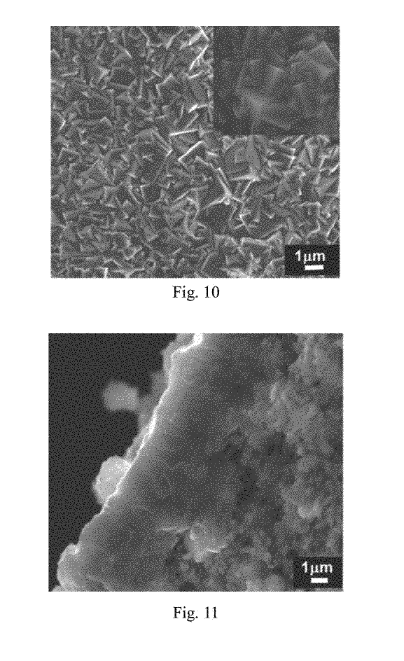

FIG. 10 is a SEM micrograph of the surface of the LTA (NaA) molecular sieve membrane layer prepared according to Example 4 of embodiments of the present invention;

FIG. 11 is a SEM micrograph of the section of the LTA (NaA) molecular sieve membrane layer prepared according to Example 4 of embodiments of the present invention;

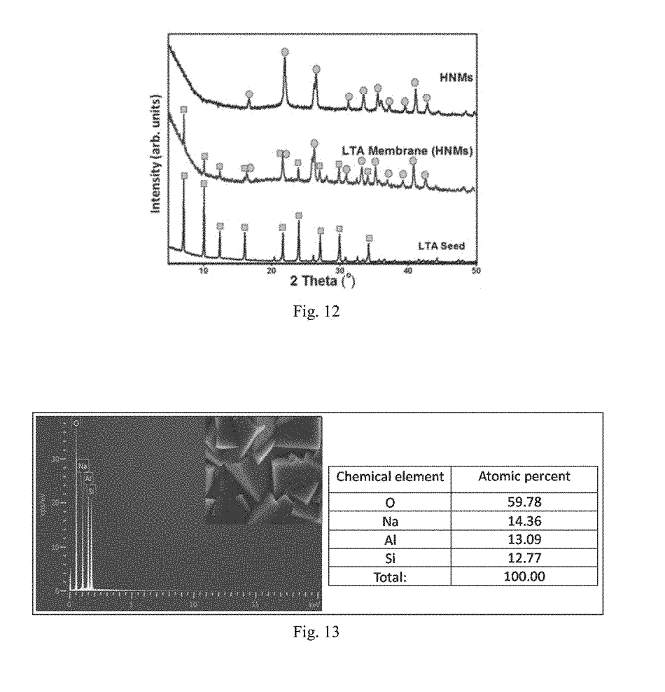

FIG. 12 shows X-Ray diffraction patterns of the seed crystals for LTA (NaA) molecular sieve, the support layer and the composite molecular sieve membrane synthesized according to Example 4 of embodiments of the present invention, wherein the square “□” refers to the diffraction peaks of the seed crystals for LTA (NaA) molecular sieve, and the circle “∘” refers to the diffraction peaks of the support layer;

FIG. 13 is a diagram showing SEM-EDX element analysis of the surface of the LTA (NaA) composite molecular sieve membrane prepared according to Example 4 of embodiments of the present invention;

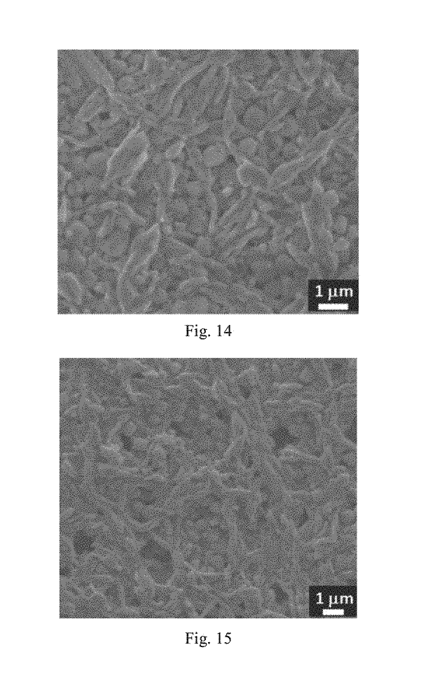

FIG. 14 is a SEM micrograph of the seed crystals for FAU (NaY) molecular sieve synthesized according to Example 5 of embodiments of the present invention when they are coated on the surface of the support layer;

FIG. 15 is a SEM micrograph of the seed crystals for FAU (NaY) molecular sieve synthesized according to Example 5 of embodiments of the present invention when they are coated on the surface of the support layer, after being ultrasonically treated for two minutes;

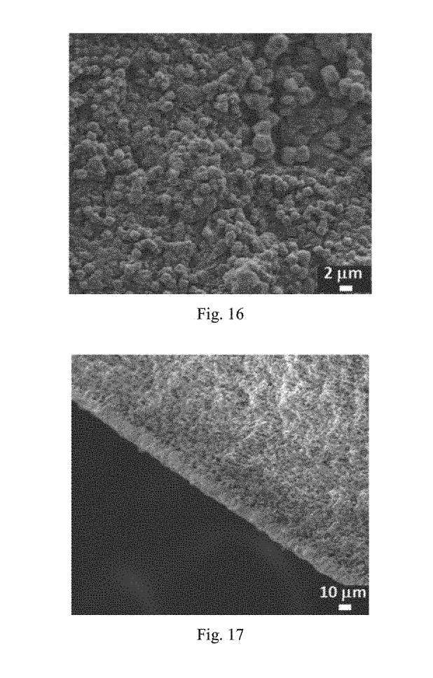

FIG. 16 is a SEM micrograph of the surface of the FAU (NaY) molecular sieve membrane layer prepared according to Example 5 of embodiments of the present invention;

FIG. 17 is a SEM micrograph of the section of the FAU (NaY) molecular sieve membrane layer prepared according to Example 5 of embodiments of the present invention;

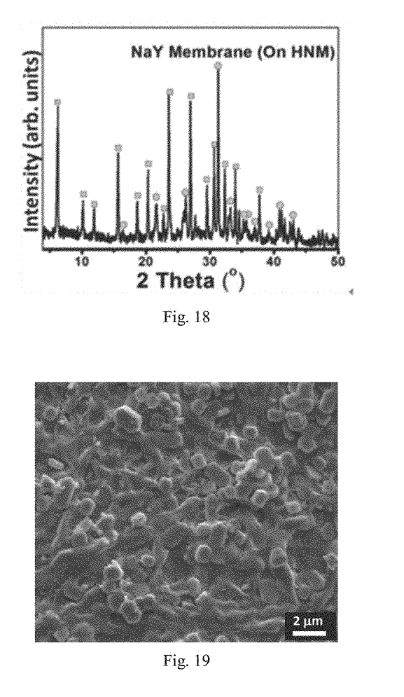

FIG. 18 is X-ray diffraction patterns of the composite molecular sieve membrane synthesized according to Example 5 of embodiments of the present invention, wherein the square “□” refers to the diffraction peaks of seed crystal for FAU (NaY) molecular sieve, and the circle “∘” refers to the diffraction peaks of the support layer;

FIG. 19 is a SEM micrograph of the seed crystals for MFI (silicalite-1) molecular sieve synthesized according to Example 6 of embodiments of the present invention, when they are coated on the surface of the support layer;

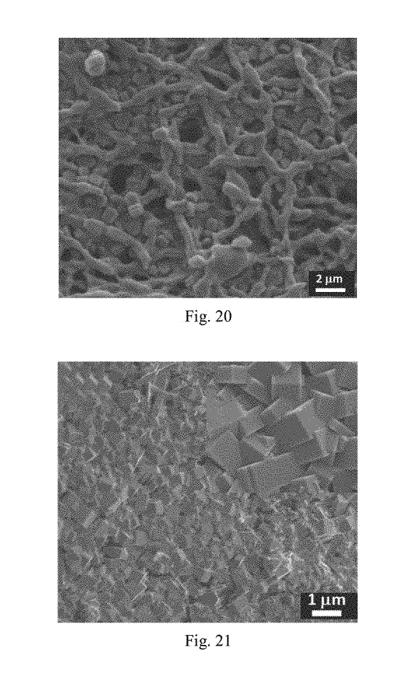

FIG. 20 is a SEM micrograph of the seed crystals for MFI (silicalite-1) molecular sieve synthesized according to Example 6 of embodiments of the present invention, when they are coated on the surface of the support layer, after being ultrasonically treated for two minutes;

FIG. 21 is a SEM micrograph of the surface of the MFI (silicalite-1) molecular sieve membrane layer prepared according to Example 6 of embodiments of the present invention;

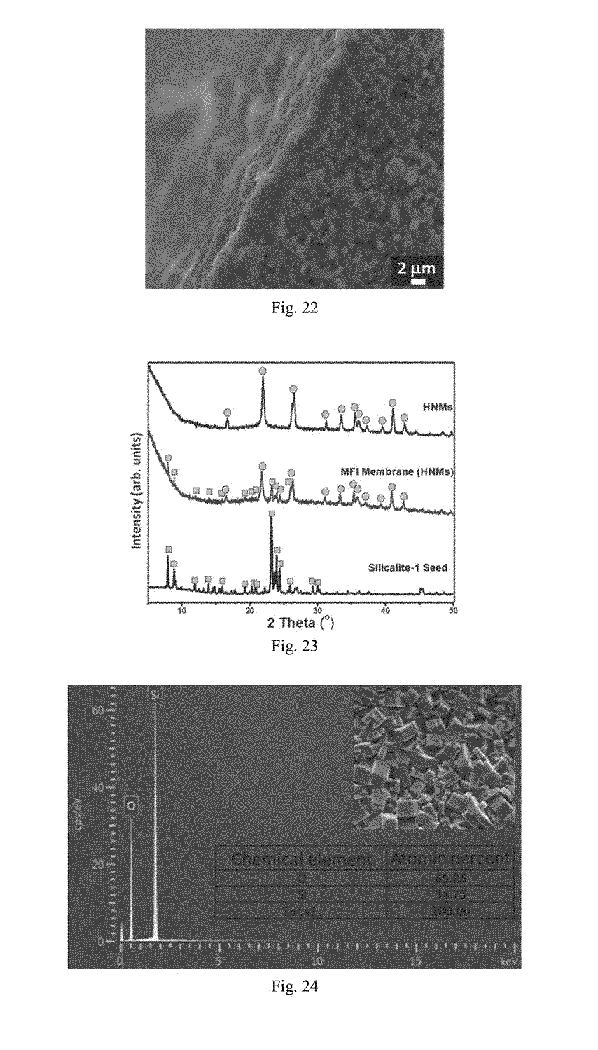

FIG. 22 is a SEM micrograph of the section of the MFI (silicalite-1) molecular sieve membrane layer prepared according to Example 6 of embodiments of the present invention;

FIG. 23 is XRD patterns of the seed crystals for MFI (silicalite-1) molecular sieve, the support layer and the composite molecular sieve membrane synthesized according to Example 6, wherein the square “□” refers to the diffraction peaks of the seed crystal for the MFI (silicalite-1) molecular sieve, the circle “∘” refers to the diffraction peaks of the support layer;

FIG. 24 is a diagram showing SEM-EDX element analysis to the surface of the MFI (silicalite-1) composite molecular sieve membrane prepared according to Example 6 of embodiments of the present invention;

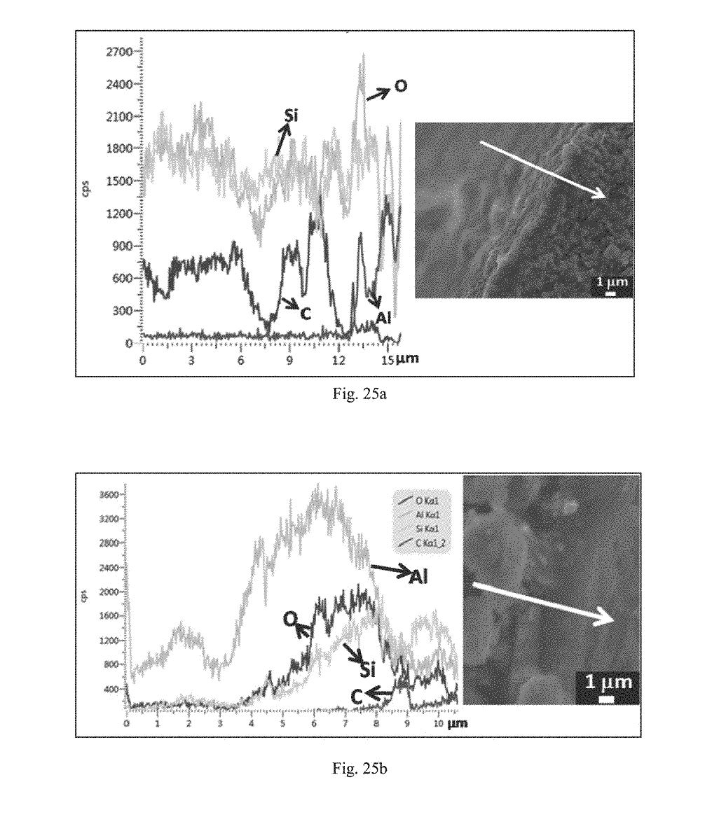

FIG. 25(a) is the SEM micrograph of the section and the SEM-EDX element analysis curves of the composite molecular sieve membrane prepared according to Example 6;

FIG. 25(b) is the SEM micrograph of the section and the SEM-EDX element analysis curves of the molecular sieve membrane prepared based on commercially available α-Al₂O₃ support in the contrast test 1;

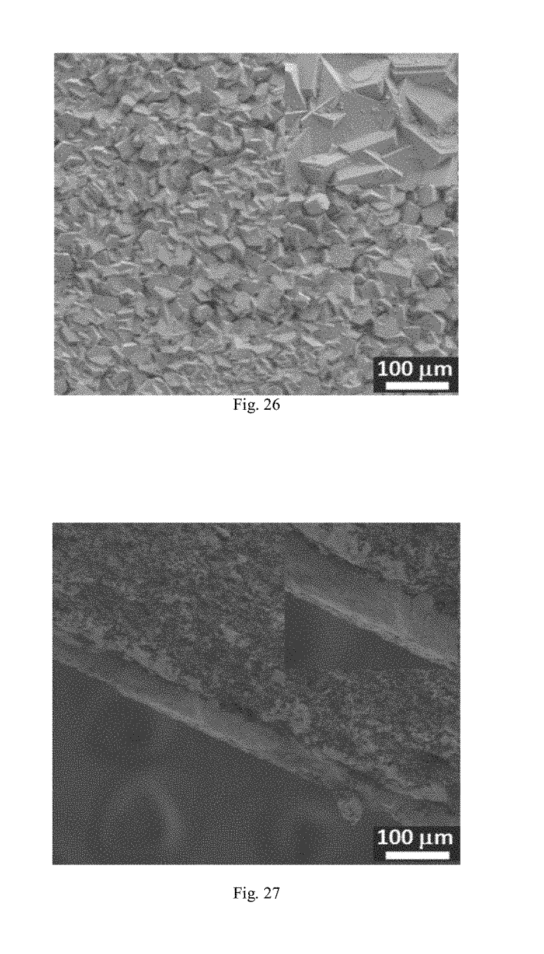

FIG. 26 is a SEM micrograph of the surface of the AFI (AlPO₄-5) molecular sieve membrane layer prepared according to Example 7 of embodiments of the present invention, when it is formed on the surface of the support layer of Example 2;

FIG. 27 is a SEM micrograph of the section of the AFI (AlPO₄-5) molecular sieve membrane layer prepared according to Example 7 of embodiments of the present invention, when it is formed on the surface of the support layer of Example 2;

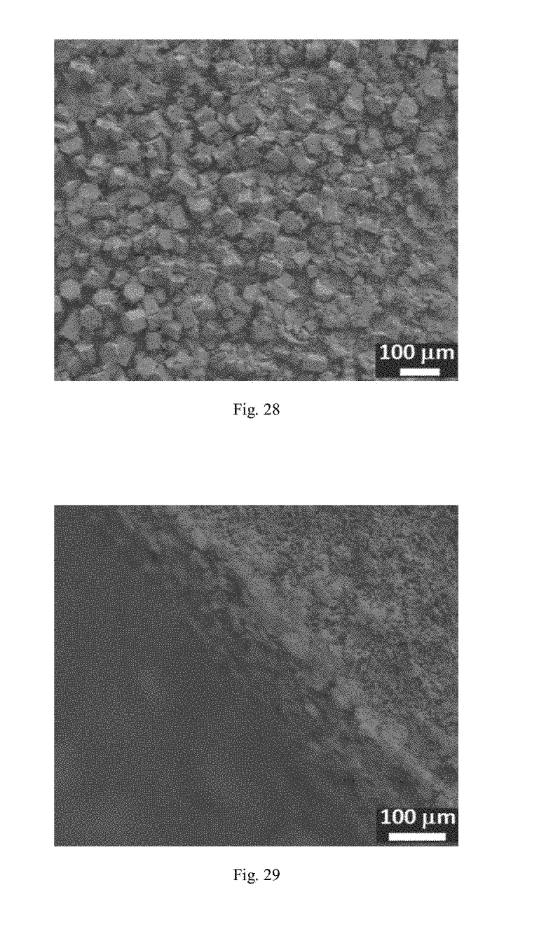

FIG. 28 is a SEM micrograph of the surface of the AFI (AlPO₄-5) molecular sieve membrane layer prepared according to Example 7 of embodiments of the present invention, when it is formed on the surface of the commercially available α-Al₂O₃ support;

FIG. 29 is a SEM micrograph of the section of the AFI (AlPO₄-5) molecular sieve membrane layer prepared according to Example 7 of embodiments of the present invention, when it is formed on the surface of the commercially available α-Al₂O₃ support;

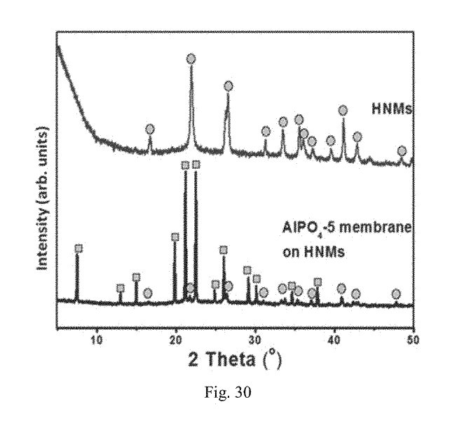

FIG. 30 shows the X-ray diffraction patterns of the support layers synthesized according to Example 2, and the composite molecular sieve membrane prepared based on the support layer, in Example 7 of embodiments of the present invention, wherein the square “□” refers to the diffraction peaks of crystals for AFI (AlPO₄-5) molecular sieve, and the circle “∘” refers to the diffraction peaks of support layer.

### DETAILED DESCRIPTION

The composite molecular sieve membrane of the embodiments of the present invention applies the high-porosity and porous ceramic prepared by electrospinning as the support layer, and it overcomes the drawbacks that the existing ceramic support layer sintered by particles is difficult to form the membrane, and that the manufactured membrane has low flux and poor selectivity. In addition, in the preferable technical solution of the embodiments of the present invention, continuous molecular sieve membrane layer is synthesized on the high-porosity and porous ceramic support layer through the methods of secondary growth, in-situ hydrothermal synthesis or vapor-phase transport (VPT), whereby the composite molecular sieve membrane of the embodiments of the present invention has the advantage of high flux and good selectivity in separation application.

The high-porosity and porous ceramic support layer prepared through electrospinning process of the embodiments of the present invention has good corrosion resistance, high porosity, uniform pore sizes, and high flux, etc., and it is easy for seed crystal coating and molecular sieve membrane layer growth. The porous ceramic support layer prepared through electrospinning process of the embodiments of the present invention have a uniform size distribution and an adjustable pore size, wherein the pore channel is formed by mutually crystallized inorganic fibers, the porosity is up to 83% and is adjustable from 40% to 83%. It is more important that a self-supported support layer in millimeter scale can be prepared by choosing proper spinning auxiliaries, e.g. choosing and using the polymers, and by adjusting the spinning parameters, applying a needle/needle-free electrospinning, adjusting the pre-treatment condition for the composite fiber membrane such as the temperature and duration time for pre-oxidation, choosing pressure of 0.01 to 40 MPa for press forming of composite fiber membrane; and by accurate control of calcination temperature and recrystallization, for example, during the calcination, the temperature is increased to 500 to 1700° C. through multiple stages or one stage, and is kept for 1 to 10 hours, in an atmosphere of air, oxygen, nitrogen, argon or vacuum, under a sintering pressure of 0 to 500 Mpa. The mechanical strength of the electrospun inorganic nanofiber membrane can be increased by effectively controlling the recrystallization and the fusion and embedment during the calcination of the spinning fibers for removing organic auxiliaries, and increasing the thickness of the membrane, and these processes determine whether the electrospun inorganic nanofiber membrane can be applied on the support of the molecular sieve membrane. The electrospun nanofiber support prepared in the embodiments of the present invention are self-supported due to its high mechanical strength, and the support has a thickness of up to 5 mm, which takes a leading position in the field of the electrospun inorganic nanofiber membrane.

In a preferable technical solution of the embodiments of the present invention, three methods, i.e. secondary growth method, in-situ hydrothermal synthesis method and vapor-phase transport method, used for preparing the molecular sieve membrane layer are provided. The molecular sieve membrane layer of the embodiments of the present invention has a smooth and completed surface, good continuity, small and controllable thickness. Through the separation application, it is verified that the molecular sieve membrane layer has a high separation flux and good selectivity. In the in-situ hydrothermal synthesis method of the embodiments of the present invention, the molecular sieve membrane layer can be prepared by one-time in-situ hydrothermal synthesis, and such preparation is simpler and more convenient. In the secondary growth method, a step of coating seed crystals on the support layer and a subsequent hydrothermal synthesis based on the former are comprised. It should be noted that the step of coating seed crystals is significant for the formation of molecular sieve membrane layer, because the pre-coated seed crystals are capable of providing nucleation sites for subsequent hydrothermal synthesis, which is good for components of the synthesizing solution to grow a completed, dense and flawless molecular sieve membrane layer by the existence of seed crystals, and the step of coating seed crystals would also prevent other crystal forms from occurring. The support layer of the embodiments of the present invention is well matched and compatible, and different coating methods can be applied to coat completed seed crystal layer on the support layer rapidly and efficiently, and to effectively avoid the detachment of the seed crystal layer. The secondary growth method performed by hydrothermal synthesis method is used to prepare various molecular sieve membrane layers having continuous and completed surfaces, a small thickness, a high separation flux and a good selectivity.

With regarding to the in-situ hydrothermal synthesis method, the support layer is put directly in the synthesizing solution or the synthesizing solution being ageing treated, and the molecular sieve membrane is directly synthesized the on the support at a certain temperature. In an example of the embodiments of the present invention, the electrospun nanofiber support layer prepared in the embodiments of the present invention is directly placed into the AlPO₄-5 synthesizing solution being aging treated, and a completed and flawless AlPO₄-5 molecular sieve membrane can be prepared through one-time hydrothermal synthesis.

The secondary growth method comprises two steps of: 1) attaching the hydrothermally synthesized seed crystals for molecular sieve to the porous support layer; and 2) placing the support attached with seed crystals into the synthesizing solution or synthesizing solution being aging treated, to synthesize the same type of molecular sieve membrane layer under the guidance of the attached seed crystals. The seed crystals can be coated through vacuum process, ultrasonic method, impregnation method, hot impregnation method, roll coating, dry coating method, or wet coating method, etc., wherein the wet coating method may use water, ethanol, methanol, propyl alcohol, isopropanol, formic acid, glacial acetic acid, methylbenzene or DMF as the solvent. In an example of the embodiments of the present invention, the seed crystals for LTA molecular sieve are firstly prepared, and then are coated on the surface of the porous ceramic support layer through wet-coating method, after that the porous ceramic support layer coated with seed crystal is placed into the synthesizing nutrient solution for a further growth of the crystals, whereby the composite LTA molecular sieve membrane layer is obtained.

With regarding to the vapor-phase transport method, carriers are usually immersed in the synthesizing solution for zeolite molecular sieve for several times, to make synthesizing materials for molecular sieve adhere to the carriers evenly, then a dense molecular sieve membrane would be prepared after a period of reaction in the vapor or mixed steam of template and water.

It should be noted that the molecular sieve membrane layer of the embodiments of the present invention can be formed of aluminosilicate, in a silicon/aluminum ratio from 1 to infinity. In an example of the embodiments of the present invention, the prepared LTA (NaA) molecular sieve membrane has a silicon/aluminum ratio of 1; and in another example of the embodiments of the present invention, the prepared MFI (silicalite-1) molecular sieve membrane has a silicon/aluminum ratio of infinity. In one example of the embodiments of the present invention, natural halloysites nanotubes are applied as the raw material to form the high-porosity electrospun porous ceramic support layer, and such raw material is cheap and is easily acquired and has a very high resource share. Besides, the effects of halloysites nanotubes on the stress intensification and the decrease of coefficient of thermal expansion have been previously reported, thus it is more advantageous for the halloysites nanotubes to act as the inorganic spinning materials, compared with other inorganic materials, such as SiO₂, TiO₂, Al₂O₃, etc. Meanwhile, considering the structural advantages of the support layer itself of the embodiments of the present invention, that is, the aluminum atoms are wrapped in the inner of the halloysite nanotubes, and are difficult to escape during the preparation of MFI (silicalite-1) molecular sieve membrane layer. It has been verified in the embodiments of the present invention that the prepared molecular sieve membrane layer is constituted of pure silicon without the presence of aluminum element. In contrast, the aluminum element will permeate into the molecular sieve membrane layer from the support layer, if the commercially available aluminum oxide support layer is used to synthesize the molecular sieve membrane, thus it is impossible to obtain a molecular sieve membrane layer formed of pure silicon even an aluminum-free formula is applied.

Furthermore, in the molecular sieve membrane layer of the embodiments of the present invention, the silicon and aluminum can be occupied or replaced by heteroatom, wherein the heteroatom may be phosphorus, boron, germanium, titanium, zirconium, gallium, vanadium, cobalt, or iron atom. The molecular sieve membrane layer can be the type selected from 200 types of zeolite published by international zeolite association on its website http://www.iza-structure.org/, and other molecular sieve types reported on literatures. The frame of the molecular sieve can be formed by four-, six-, eight-, ten-, twelve-, fourteen-, and the like, even thirty-membered ring. For example, in an example of the embodiments of the present invention, the LTA frame of the prepared LTA molecular sieve membrane layer is formed by four-, six-, and eight-membered ring, wherein the main pore channel of the LTA molecular sieve, which is 0.41 nm, is mainly determined by eight-membered ring. The synthesized molecular sieve membrane layer uses a silicon source comprising silica sol, silicon oxide, tetraethyl orthosilicate, sodium metasilicate, n-butyl silicate, and silicon carbide, etc; a aluminum source comprising aluminum foil, aluminum powder, aluminum oxide, aluminum chloride, sodium metaaluminate, aluminum sulfate, aluminum nitrate, aluminum isopropoxide, pseudo-boehmite, and aluminium hydroxide, etc; a heteroatom source comprising phosphoric acid, boric acid, germanium tetraethoxide, tetrabutyl titanate, bis(cyclopentadienyl)zirconium dichloride, gallium phosphate, ammonium metavanadate, cobalt chloride, and ferric nitrate, etc; an optional template comprising organic amine or quaternary ammonium salt such as tetrapropylammonium hydroxide, tetrapropylammonium bromide, tetraethylammonium hydroxide, tetramethylammonium hydroxide, triethylamine, dipropylamine, cyclohexylamine, N,N-dimethylaminobutane, N,N-dimethylethanolamine, tetraethylammonium chloride, morpholine, hexadecyltrimethylammonium bromide, hexadecyltrimethylammonium chloride, all kinds of surfactant, or an organic template according to various types of zeolites. The optional alkali for synthesis may be sodium hydroxide, potassium hydroxide, ammonium hydroxide, calcium hydroxide, aluminum hydroxide, silver hydroxide, zinc hydroxide, cesium hydroxide, potassium carbonate, sodium carbonate, ammonia solution, hydrazine, hydroxylamine, or liquid ammonia etc.

Furthermore, the molecular sieve membrane layer of the embodiments of the present invention can be synthesized in containers which comprise but are not limited to, hydrothermal reaction kettle, three-necked flask, piston flow reactor or full-automatic autoclave. The oven heating, microwaves heating and muffle furnace heating, etc., can be used to provide the heat energy. The molecular sieve membrane layer can be synthesized at a temperature in a range from 30 to 500° C. and under a pressure between 1 and 30 bar, for 30 min to 300 hours. Different molecular sieve membrane layers may be synthesized by choosing different synthesis conditions according to actual requirements. The synthesis condition for molecular sieve membrane layer is known for one skilled in the art, thus it is not defined here.

It is noted that a template removing process is required for the molecular sieve membrane layer having templates. Such removing process comprises calcination, organic solvent washing, ozone oxidization method, etc. The calcination may be performed in the muffle furnace or tube furnace, at a temperature in a range between 550 and 1000° C., preferably between 550 and 600° C., for 2 to 24 hours, preferably for 2-3 hours. In a more preferable solution, the calcination may be performed in a temperature gradient between 0.1 and 10° C./min.

In the embodiments of the present invention, an electrospinning process is applied to prepare the high-porosity and porous nanofiber ceramic, which acts as the support layer. A composite molecular sieve membrane with high flux and good selectivity is synthesized based on the fiber ceramic support layer. The support layer of the embodiments of the present invention is controllable in microstructure, and it has a thickness of up to 5 mm, a flat and continuous surface, an adjustable and uniform pore size, a porosity of up to 83%, and pore channels with low tortuosity, whereby the support layer is advantageous in big flux and high mechanical strength. The support layer of the embodiments of the present invention has fibrous pore channels which are easily to match different sizes of molecular sieve crystals, thus it is helpful for the seed crystal coating and the molecular sieve membrane growth on the support layer. The coated seed crystals or synthesized molecular sieve crystals are embedded in the cavities of the support, ensuring the stability of seed crystals in the support, and a large number of seed crystals still stay under an external force. Meanwhile, the porous ceramic support layer of the embodiments of the present invention may be widely used in the preparation of the molecular sieve membrane, in view of the hydrophilic and organophilic characteristics of the support layer itself. The composite molecular sieve membrane of the embodiments of the present invention is synthesized by simple and widely applicable processes, and the membrane will be created after a fewer number of times. The membrane is thin, and has big separation flux, good selectivity and low cost.

Taking the preparation of molecular sieve membrane layer through the secondary growth method as an example, the preparation method of the composite molecular sieve membrane of the embodiments of the present invention will be illustrated with reference to FIG. 1, and it comprises the following steps:
(1) dispersing the nano- or submicron ceramic powder materials/ceramic material precursors in the solvent, adding a polymer and stirring them to obtain an uniform spinning solution for electrospinning;
(2) applying the electrospinning method to prepare the ceramic material/polymer composite fibrous membrane with the spinning solution;
(3) pre-treating the ceramic material/polymer composite fibrous membrane and press-forming it;
(4) sintering the press formed composite fibrous membrane for removing the polymer, in order to obtain a support layer;
(5) forming a continuously distributed molecular sieve membrane layer on the surface of the support layer through the secondary growth method, that is, preparing the composite molecular sieve membrane, wherein the secondary growth method comprises steps that the seed crystals are firstly coated on the surface of the support layer and then the seed crystals in the culture solution grow to obtain the molecular sieve membrane layer.

The embodiments of the present invention will be further explained in detail in following preferred embodiments, and these embodiments are used for further explanation of the embodiments of the present invention, instead of limitation.

### Example 1

In the Example, a method for preparing high-porosity and porous ceramic support layer is provided as follows.

The DMF and ethanol in a weight ratio of 1:2 are mixed to obtain a mixed solution.

Halloysite nanotubes (HNTs) are added into the mixed solution, and are ultrasonically dispersed to eliminate agglomerates. The polyvinylpyrrolidone (PVP) are added, wherein the weight ratio of PVP to the mixed solution is 3:22, and the weight ratio of HNTs to PVP is 2:3. After an intensive mixing, a uniform solution for electrospinning is prepared.

A needle electrospinning process is applied. The prepared spinning solution is transferred into a disposable syringe for electro spinning, and the inner diameter of the needle of the syringe is 0.4 mm. The voltage for electrospinning is 5 KV, and the pumping speed is 30 μL/min. The distance between the needle and the collecting rolling cylinder is 10 cm, and the rotation speed of the collecting rolling cylinder having a diameter of 10 cm is 2000 rpm. The ceramic material/polymer composite fiber membrane is prepared.

The ceramic material/polymer composite fiber membrane is preprocessed to pre-oxidize at a temperature of 150° C. for 48 hours. Then the composite fiber membrane is pressed by a ceramic tablet press (ZP21U) under a pressure of 5 MPa, to obtain a product which is then transferred into a tube furnace (OTF-1200× vacuum hot-pressing furnace) for a high temperature sintering. The high temperature sintering is carried out as following steps: firstly, heating the samples at a heating rate of 3° C./min to slowly deform the polymer in the samples, so as to control the warpage of the product; then keeping the samples at a PVP pyrolysis temperature of, e.g., 390° C., for 1 hour, to provide enough time for the pyrolysis of PVP; after that, the furnace is slowly heated to 1000° C. at a heating rate of 10° C./min and then the temperature will be kept for 4 hours. The sintering is carried out in air atmosphere, and a porous ceramic support layer is obtained after the sintering.

The prepared porous ceramic support layer is observed by SEM, the pore size of the prepared porous ceramic support layer is tested by the mercury intrusion method, and the porosity of the prepared porous ceramic support layer is tested by the vacuum impregnation method.

The result observed by SEM is shown in FIG. 2, and it can be found that the porous ceramic support layer prepared in this example has uniform pore sizes and uniform distribution of pore sizes, which provides a solid foundation for the subsequent coating and growth of seed crystals for molecular sieve membrane layer.

The result of pore size of the porous ceramic support layer tested by the mercury intrusion method shows that the porous ceramic support layer prepared in this example has pore sizes between 0.06 and 3 μm, and their distribution concentrates around 1.05 μm. The pore sizes and their distribution are uniform, which corresponds to the observation result of SEM.

The result of porosity tested by the impregnation method shows that the porous ceramic support layer prepared in this example has a porosity of 68%, which is highly increased when compared with the commercially available support layers, and this provides a solid foundation for preparing the high-flux composite molecular sieve membrane.

### Example 2

In the Example, another method for preparing high-porosity and porous ceramic support layer is provided as follows.

The water and ethanol in a weight ratio of 1:2 are mixed to obtain a mixed solution.

Halloysite nanotubes (HNTs) are added into the mixed solution, and are ultrasonically dispersed to eliminate agglomerates. The polyvinylpyrrolidone (PVP) is added, wherein the weight ratio of PVP to the mixed solution ratio is 3:22, and the weight ratio of HNTs to PVP is 2:3. After an intensive mixing, a uniform solution for electrospinning is prepared.

A needle-free electrospinning technology is applied. The prepared electrospinning solution is transferred into a fluid carrying device for electrospinning. The voltage for electrospinning is 60 KV, the distance between the receiving electrode and the spinning electrode is 240 mm. The travelling speed of the fluid carrying device is 300 mm/s, while the travelling speed of the collecting substrate is 10 mm/min. Then the ceramic material/polymer composite fiber membrane is prepared.

The prepared ceramic material/polymer composite fibrous membrane is preprocessed to pre-oxidize at a temperature of 200° C. for 24 hours. Then the composite fibrous membrane is pressed by a ceramic tablet press (ZP21U) under a pressure of 11.1 MPa, to obtain a product which is then transferred into a tube furnace (OTF-1200× vacuum hot-pressing furnace) for a high temperature sintering. The high temperature sintering is performed as following steps: heating the samples at a heating rate of 3° C./min to slowly deform the polymer in the samples, so as to control the warpage of the product; then decreasing the heating rate to 1° C./min when the temperature is in the PVP pyrolysis temperature range between 350° C. and 450° C., to provide enough time for the pyrolysis of PVP; after that, the furnace is slowly heated to 1400° C. at a heating rate of 5° C./min and then the temperature will be kept for 4 hours. The sintering is carried out in air atmosphere, and a porous ceramic support layer is obtained after the sintering.

The prepared porous ceramic support layer is observed by SEM, the pore size of the prepared porous ceramic support layer is tested by the mercury intrusion method, and the porosity of the prepared porous ceramic support layer is tested by the vacuum impregnation method.

As shown in FIG. 3, the porous ceramic support layer product is in sheets and its diameter is up to 50 mm and its thickness is adjustable between 1 and 5 mm.

The result observed by SEM is shown in FIG. 4, and it can be found that the porous ceramic support layer prepared in this example has a uniform pore size and uniform distribution of pore sizes, which provides a solid foundation for the subsequent coating and growth of seed crystals of molecular sieve membrane layer.

SEM-EDX is used for a micro element analysis for the porous ceramic support layer, and the result in FIG. 5 shows that the silicon/aluminum ratio in the support layer is nearly 1:1, and the corresponding SEM paragraph is presented at the top right corner of FIG. 5.

Besides, the result of pore size of the porous ceramic support layer tested by the mercury intrusion method shows that the porous ceramic support layer prepared in this example has pore sizes between 0.5-2 μm, and their distribution concentrates around 1.05 μm. The pore sizes and their distribution are uniform, as shown in FIG. 6, and this corresponds to the observation result of SEM.

The result of porosity tested by the impregnation method shows that the porous ceramic support layer prepared in this example has a porosity of 71%, which is highly increased when compared with the commercially available support layers, and this provides a solid foundation for preparing the high-flux composite molecular sieve membrane.

### Example 3

In the Example, a method for preparing high-porosity and porous ceramic support layer is provided as follows.

The tetraethyl titanate is added into the ethanol (EtOH) to obtain a mixed solution, and then the polyvinylpyrrolidone (PVP) is added. The weight ratio of PVP to the solution is 1:10, and the weight ratio of tetraethyl titanate to PVP is 1:1. After an intensive mixing, a uniform solution for electrospinning is prepared.

The prepared spinning solution is transferred into a disposable syringe for the electrospinning, and the inner diameter of the needle of the syringe is 0.4 mm. The voltage for electrospinning is 20 KV, and the pumping speed is 20 μL/min. The distance between the needle and the collecting rolling cylinder is 10 cm, and the rotation speed of the collecting rolling cylinder having a diameter of 10 cm is 100 rpm. The ceramic material/polymer composite fiber membrane, i.e., titanium dioxide/PVP composite fibrous membrane, is prepared.

The titanium dioxide/PVP composite fiber membrane is preprocessed to pre-oxidize at a temperature of 170° C. for 48 hours. Then the composite fibrous membrane is pressed by a ceramic tablet press (ZP21U) under a pressure of 0.5 MPa, to obtain a product which is then transferred into a tube furnace (OTF-1200× vacuum hot-pressing furnace) for a high temperature sintering. The high temperature sintering is performed as following steps: heating the samples at a heating rate of 3° C./min to slowly deform the polymer in the samples, so as to control the warpage of the product; keeping the samples at a PVP pyrolysis temperature of, e.g., 390° C., for 1 hour, to provide enough time for the pyrolysis of PVP; after that, the furnace is slowly heated to 800° C. at a heating rate of 10° C./min and then the temperature will be kept for 2 hours. The sintering is carried out in air atmosphere, and a porous ceramic support layer is obtained after the sintering.

The prepared porous ceramic support layer is observed by SEM, the pore size of the prepared porous ceramic support layer is tested by the mercury intrusion method, and the porosity of the prepared porous ceramic support layer is tested by the vacuum impregnation method.

The result observed by SEM is shown in FIG. 7, and it can be found that the porous ceramic support layer has uniform pore sizes and uniform distribution of pore sizes, which provides a solid foundation for the subsequent coating and growth of seed crystals of molecular sieve membrane.

The result of pore sizes of the porous ceramic support layer tested by the mercury intrusion method shows that the porous ceramic support layer has pore sizes between 0.2-3 μm, and their distribution concentrates around 1.05 μm. The pore sizes and their distribution are uniform, which corresponds to the observation result of SEM.

The result of porosity tested by the impregnation method shows that the porous ceramic support layer has a porosity of 83%, which is highly increased when compared with the commercially available support layers, and this provides a solid foundation for preparing the high-flux composite molecular sieve membrane.

### Example 4

In this Example, a molecular sieve membrane is prepared based on high-porosity and porous ceramic support layer prepared in the Example 2, wherein the molecular sieve membrane layer is LTA (NaA) molecular sieve membrane layer. The preparation of the LTA (NaA) molecular sieve membrane comprises the preparation of the NaA molecular sieve seed crystal and the synthesis of the molecular sieve membrane layer.

A template-free synthesis method is applied in this Example, and the seed crystals for NaA molecular sieves are prepared by the hydrothermal synthesis method. Then the seed crystals are coated on the surface of the support layer, and they are attached effectively through a stoving or calcining process. The membrane synthesizing solution is prepared according to the composition of the template-free NaA molecular sieve membrane, and an ageing treatment is applied. The support layer coated with seed crystals is placed into the membrane synthesizing solution after the ageing treatment, to react at a temperature of 100° C. for 3-5 hours, and then the completed NaA molecular sieve membrane is prepared. The synthesizing solution for seed crystals comprises 1 part by weight of Al₂O₃, 0.5 to 2 parts by weight of SiO₂, 2 to 8 parts by weight of Na₂O and 30 to 500 parts by weight of H₂O. The membrane synthesizing solution for NaA molecular sieve membrane layer comprises 1 part by weight of Al₂O₃, 0.5 to 2 parts by weight of SiO₂, 2 to 8 parts by weight of Na₂O and 120 to 1000 parts by weight of H₂O. Specifically, in the Example, the synthesizing solution for the seed crystals comprises 1 part by weight of Al₂O₃, 2 parts by weight of SiO₂, 2 parts by weight of Na₂O and 120 parts by weight of H₂O. The membrane synthesizing solution for NaA molecular sieve membrane layer comprises 1 part by weight of Al₂O₃, 2 parts by weight of SiO₂, 2 parts by weight of Na₂O and 150 parts by weight of H₂O.

The method can be performed specifically as follows. The 12.54 mL ludox (Qingdao Haiyang, 25%) is dissolved in 20 mL deionized water, and is stirred for more than 15 minutes to achieve an evenly dispersed solution which is marked as the silicon source. The 2.4 g sodium hydroxide and 4.92 g sodium metaaluminate are dissolved in 34 mL deionized water, and are stirred to obtain a clear solution which is marked as the aluminum source. The aluminum source is dropped into the silicon source and stirred continuously. After an ageing process at room temperature for 3 hours, the mixture is transferred into the oven and heated to a temperature of 100° C. A centrifugal treatment is applied to collect white solids 3 hours after the temperature reaches 100° C., and these solids are dried at a temperature of 60° C. to obtain the seed crystals of this example. The prepared seed crystals are coated on the surface of the support layer prepared in Example 2, through a wet-coating method with 20% ethyl alcohol as the solvent, and the seed crystals will attach effectively after a drying treatment at a temperature of 60° C. A membrane synthesizing solution comprising 1 part by weight of Al₂O₃, 2 parts by weight of SiO₂, 2 parts by weight of Na₂O and 150 parts by weight of H₂O, according to the composition of NaA molecular sieve membrane, is prepared with the same method as that for preparing the synthesizing solution for seed crystals. An ageing treatment is applied for the membrane synthesizing solution at an ageing temperature of 50° C. for 8 hours. The support layer coated with seed crystal is placed in the membrane synthesizing solution, and is transferred into the oven to react at a temperature of 100° C. for 3 hours, to prepare a completed NaA molecular sieve membrane layer. In order to obtain a more completed molecular sieve membrane, the above molecular sieve membrane may be placed in a new membrane synthesizing solution again to react at a temperature of 100° C. for 3 hours, thus a more completed molecular sieve membrane layer which has better compactness will be obtained.

In addition, in order to verify that the support is helpful for the effective attachment of seed crystals, the same batch of supports are coated with the same seed crystals by the same coating procedures, and the support coated with seed crystals are ultrasonically treated for 2 minutes and then dried. The support is then observed by the electronic microscope.

In this Example, the surfaces of the prepared support layers are observed by SEM, wherein one of the surfaces is coated with seed crystals and dried, and another is coated with seed crystals and treated with ultrasonic waves for 2 minutes before drying, and the results are shown in FIG. 8 and FIG. 9 respectively. FIG. 8 shows the result of the surface of the dried support layer coated with seed crystals observed by SEM, and FIG. 9 shows the result of the surface of the support layer coated with seed crystals and treated with ultrasonic wave for 2 minutes before drying observed by SEM. As shown in FIG. 8, the particles of the seed crystals prepared in the Example are cubical with particle sizes between 0.8 and 1.2 μm and have smooth surfaces. Besides, it can be seen from FIG. 8 and FIG. 9 that the coating layers of the seed crystals are continuous and uniform, and some seed crystals are embedded in the network of support, which ensures the stability of seed crystals on the support and prevents the detachment of seed crystals. It can be seen from FIG. 9 that most of the seed crystals remain after an ultrasonic treatment lasting for 2 minutes. In sum, the support layer of Example 2 guarantees the coating efficiency of seed crystals and prevents the detachment and absence of seed crystals when placed in the membrane synthesizing solution later.

In this Example, a composite molecular sieve membrane is prepared based on the dried support layer coated with seed crystals without ultrasonic treatment. The result of the surface of the composite molecular sieve membrane observed by SEM is shown in FIG. 10, and the result of the section of the molecular sieve membrane observed by SEM is shown in FIG. 11. It can be found that the molecular sieve membrane prepared in the example has a completed and flawless surface, and the thickness of the LTA (NaA) molecular sieve membrane layer is between 3 and 5 μm. A SEM image with higher magnification is presented at the top right corner in FIG. 10.

Further, the seed crystals for LTA (NaA) molecular sieve synthesized in this Example, the support layer of Example 2 and the final composite molecular sieve membrane of this Example are analyzed by X-ray diffraction, and the results are shown in FIG. 12, wherein the square “□” refers to the diffraction peaks of the material for the LTA (NaA) molecular sieve seed crystals, and the circle “◯” refers to the diffraction peaks of the material for the support layer. The result shows that the XRD patterns comprise all characteristic diffraction peaks of the NaA molecular sieve without any impurity peaks, thus it can be verified that pure seed crystals for NaA molecular sieve have been obtained. The XRD patterns of the composite molecular sieve membrane also comprise all the characteristic diffraction peaks of the seed crystals for molecular sieve and the characteristic diffraction peak of the support layer, which proves that an ideal composite molecular sieve membrane having a small thickness is obtained. SEM-EDX is used for an element analysis on surface of the composite molecular sieve membrane prepared in this Example, and the result is shown in FIG. 13, wherein the Si/Al ratio is nearly 1:1, which corresponds to the anticipation. The corresponding SEM image is presented at the top right corner in FIG. 13.

Further, a separation test of ethyl alcohol-water mixture is carried out for the LTA (NaA) composite molecular sieve membrane prepared in this Example. The separation test of ethyl alcohol-water mixture is carried out as following steps.

At the material side, the mixture comprises 90 wt. % ethyl alcohol and 10 wt. % water, based on the mixture, and it is heated to a temperature of 75° C. In the pervaporation test, the vapour in the mixed steam enters the permeation side through the composite molecular sieve membrane, and is collected at the cold trap at a temperature of liquid nitrogen temperature. During the pervaporation process, the transmembrane pressure difference ΔP is 5 bar. The flux and separation selectivity of the composite molecular sieve membrane in unit area and unit time can be calculated by weighting the permeation side and measuring water content at the permeation side by moisture titration instrument, and the formula is as follows:

$$Flux = \frac{weight of the permeation side ( kg )}{membrane area ( {m}^{2} ) \times time ( h )}$$

wherein the unit for the flux is kg·m⁻²·h⁻¹;

$$Selectivity = \frac{\begin{matrix}water content at the permeation side ( \% ) / \\ ethyl alcohol content at the permeation side ( \% )\end{matrix}}{\begin{matrix}water content at the raw material side ( \% ) / \\ ethyl alcohol content at the raw material side ( \% )\end{matrix}}$$

The test result shows that the flux of the composite molecular sieve membrane of this Example is up to 5.1 kg·m⁻²·h⁻¹, and the selectivity is up to 9880.

### Example 5

In this Example, a molecular sieve membrane is also prepared based on high-porosity and porous ceramic support layer prepared in Example 2, wherein the molecular sieve membrane layer is FAU molecular sieve membrane layer. The preparation of the FAU molecular sieve membrane comprises the preparation of the seed crystals for FAU molecular sieve and the synthesis of the molecular sieve membrane layer.

The synthesis solution for FAU molecular sieve seed crystals comprises 1 part by weight of Al₂O₃, 2 to 15 parts by weight of SiO₂, 8 to 20 parts by weight of Na₂O and 200 to 500 parts by weight of H₂O. The membrane synthesizing solution for FAU molecular sieve membrane layer comprises 1 part by weight of Al₂O₃, 2 to 15 parts by weight of SiO₂, 8 to 20 parts by weight of Na₂O and 500 to 1500 parts by weight of H₂O. Specifically, in the Example, the synthesizing solution for the FAU (NaY) seed crystal comprises 1 part by weight of Al₂O₃, 10 parts by weight of SiO₂, 8 parts by weight of Na₂O and 400 parts by weight of H₂O. The membrane synthesizing solution for NaA molecular sieve membrane layer comprises 1 part by weight of Al₂O₃, 12.8 parts by weight of SiO₂, 17 parts by weight of Na₂O and 975 parts by weight of H₂O.

The molecular sieve membrane is prepared as follows. The 10.43 mL ludox (Qingdao Haiyang, 25%) is dissolved in 15 mL deionized water and stirred for more than 15 minutes, to achieve an evenly dispersed solution which is marked as the silicon source. Then, the 2.8 g sodium hydroxide and 0.82 g sodium metaaluminate are dissolved in 26 mL deionized water and stirred to obtain a clear solution which is marked as the aluminum source. The aluminum source is dropped into the silicon source to obtain a mixture which is stirred for an ageing treatment at room temperature for 3 hours. Then the mixture is transferred into the oven and is heated to a temperature of 100° C. The centrifugal treatment is applied to collect white solids 12 hours after the temperature reaches 100° C., and the solids are dried at a temperature of 60° C. to obtain the seed crystals in this Example. Then, the prepared seed crystals are coated on the surface of the support layer prepared in Example 2 through wet-coating method with 50% ethyl alcohol as the solvent, and the seed crystals will attach effectively after a drying treatment at a temperature of 60° C. The synthesizing solution for FAU (NaY) molecular sieve membrane comprising 1 part by weight of Al₂O₃, 12.8 parts by weight of SiO₂, 17 parts by weight of Na₂O and 975 parts by weight of H₂O, according to the composition of FAU (NaY) molecular sieve membrane, is prepared. An ageing treatment is applied to the synthesizing solution of the membrane at an ageing temperature of 50° C. for 8 hours. The support coated with seed crystals is placed into the synthesizing solution of membrane, and then they are transferred into the oven to react at a temperature of 100° C. for 12 hours, so as to prepare a completed FAU molecular sieve membrane. In order to obtain a more completed molecular sieve membrane, the above molecular sieve membrane is placed in a new synthesizing solution of membrane again to react at a temperature of 100° C. for 12 hours, thus a more completed molecular sieve membrane layer which has better compactness is prepared.

In addition, in order to verify that the support is helpful for the effective attachment of seed crystals, the same batch of supports are coated with the same seed crystals by the same coating procedures, and then the support coated with seed crystal is treated by ultrasonic waves for 2 minutes before drying. The support is then observed by SEM.

The surfaces of the prepared support layers are observed by SEM, wherein one of the support layer is coated with seed crystals and dried, and another is treated with ultrasonic wave for 2 minutes before drying, and the results are shown in FIG. 14 and FIG. 15 respectively. FIG. 14 shows the result of the surface of the dried support layer coated with seed crystals observed by SEM. As shown in FIG. 14, the particles of the seed crystals prepared in the Example are octahedral bipyramid-shaped, and have particle sizes between 0.9 and 1.3 μm and smooth surfaces. FIG. 15 shows the result of surface of the support layer coated with seed crystals and treated with ultrasonic wave for 2 minutes before drying. It can be seen from FIG. 14 and FIG. 15 that the coating layer of the seed crystals is continuous and uniform, and that parts of the seed crystals are embedded in the network of support, which ensures the stability of seed crystal in the support and prevents the detachment of seed crystals. It can be seen from FIG. 15 that most of the seed crystals remain after an ultrasonic treatment lasing for 2 minutes.

The composite molecular sieve membrane, i.e., the FAU (NaY) composite molecular sieve membrane, is prepared based on the support layer coated with seed crystal without ultrasonic treatment. The result of the surface of the composite molecular sieve membrane observed by SEM is shown in FIG. 16, and the result of the section of the molecular sieve membrane observed by SEM is shown in FIG. 17. It can be found that the molecular sieve membrane prepared in the example has a completed and flawless surface, and the thickness of the FAU molecular sieve membrane layer is 5 μm. Further, the FAU (NaY) composite molecular sieve membrane synthesized in this Example is analyzed by X-ray diffraction, and the results are shown in FIG. 18, wherein the square “□” refers to the diffraction peaks of FAU (NaY) molecular sieve seed crystals, and the circle “◯” refers to the diffraction peaks of the support layer. The XRD patterns of composite molecular sieve membrane comprise all the characteristic diffraction peaks of seed crystals for molecular sieve and the characteristic diffraction peak of the support layer, which proves that ideal composite molecular sieve membrane having a small thickness is obtained.

Further, a N₂ gas permeation flow rate test and a N₂/CO₂ mixed gas separation test are carried out for the FAU (NaY) composite molecular sieve membrane.

Two important technical indicators, i.e., permeation flow rate and separation factor (selectivity), representing the permeation and separation properties respectively, are usually used to judge the performance of the air separation of the composite molecular sieve membrane prepared in this Example. The permeation flow rate of gas refers to the air flow passing through unit area in unit time period and under unit pressure, and it is calculated by the following formula:

$$Permeation flow rate = \frac{air flow permeated through the membrane ( mol )}{membrane area ( {m}^{2} ) \times time ( s ) \times Δ P ( Pa )}$$

wherein the unit of the permeation flow rate is mol/m²·s·Pa;
the separation factor of N₂/CO₂ mixed gas is calculated by the following formula:

$$Separation factor = \frac{\begin{matrix}mole fractions of {N}_{2} at the permeation side / \\ mole fractions of {CO}_{2} at the permeation side\end{matrix}}{\begin{matrix}mole fractions of {N}_{2} at the raw material side / \\ mole fractions of {CO}_{2} at the raw material side\end{matrix}}$$

In the Example, the tests for N₂ gas permeation flow rate and the N₂/CO₂ separation factor are carried out at a temperature of 303 K, and under pressure of 0.2 MPa at the material sides. The permeation flow rate at the permeation side is measured by the soap film flowmeter, and the gas component is analyzed by the gas chromatography (Shimadzu GC-2010 AF).

The test result shows that the N₂ gas permeation flow rate is 1.8×10⁻⁶ mol/m²·s·Pa, and the separation factor for N₂/CO₂ mixed gas is 7.91.

### Example 6

A molecular sieve membrane is also prepared based on high-porosity and porous ceramic support layer prepared in the Example 2, wherein the molecular sieve membrane layer is MFI (silicalite-1) molecular sieve membrane layer. The preparation of the MFI (silicalite-1) molecular sieve membrane comprises the preparation of the seed crystals for MFI (silicalite-1) molecular sieve and the synthesis of the molecular sieve membrane layer.

A template-containing synthesizing solution for the MFI (silicalite-1) seed crystals comprises “x” parts by weight of TPAOH, 1 part by weight of TEOS, and “y” parts by weight of H₂O, wherein x=0.5-1, y=30-50. The synthesizing solution for the MFI (silicalite-1) molecular sieve membrane comprises “x” parts by weight of TPAOH, 1 part by weight of TEOS, and “y” parts by weight of H₂O, wherein x=0.1-1, y=80-300.

Specifically, in the Example, the MFI (silicalite-1) molecular sieve seed crystal comprises 0.2 parts by weight of TPAOH, 1 part by weight of TEOS, and 150 parts by weight of H₂O, and the molecular sieve seed crystal is prepared by hydrothermal synthesis method.

The molecular sieve membrane is prepared as follows. 3.4 mL TPAOH (40%) is dissolved in 86 mL deionized water, and stirred for more than 15 minutes to achieve an evenly dispersed solution. 7.3 mL TEOS is dropped into the above solution and stirred to obtain a clear solution. Then the mixture is transferred into the oven and heated to a temperature of 180° C. after an ageing treatment at the room temperature for 3 hours. A centrifugal treatment is applied to collect white solids 9 hours after the temperature reaches 180° C., and the solids are dried at a temperature of 60° C. to obtain the seed crystals in this Example. Then the prepared seed crystal are coated on the surface of the support layer prepared in Example 2 through wet-coating method with 50% ethyl alcohol as the solvent, and the seed crystals will attach effectively after a drying treatment at a temperature of 60° C. The synthesizing solution of membrane comprising 0.17 parts by weight of TPAOH, 1 part by weight of TEOS, 165 parts by weight of H₂O according to the composition of MFI (silicalite-1) molecular sieve membrane, is prepared. An ageing treatment is applied to the synthesizing solution of membrane at an ageing temperature of 50° C. for 8 hours. The support layer coated with seed crystals is placed in the synthesizing solution of membrane, and then they are transferred into the oven to react at a temperature of 180° C. for 6 hours, so as to prepare a completed MFI (silicalite-1) molecular sieve membrane. In order to obtain a more completed molecular sieve membrane, the above molecular sieve membrane is placed in a new synthesizing solution of membrane again to react at a temperature of 180° C. for 9 hours, to obtain a more completed molecular sieve membrane layer which has better compactness. After the synthesis of membrane, a template removing treatment is carried out in the muffle furnace in a heating rate of 1° C./min to obtain a microporous MFI (silicalite-1) molecular sieve membrane, which is the composite molecular sieve membrane of this Example.

The surface of prepared support layer coated with seed crystals before drying is observed by SEM, and the results are shown in FIG. 19. As shown in FIG. 19, the particles of the seed crystals prepared in the Example are coffin-shaped, and have particle sizes between 0.5 and 0.8 μm and smooth surfaces. Besides, the coating layer of the seed crystals is continuous and uniform, and parts of the seed crystals are embedded in the network of the support.

In order to verify that the support is helpful for the effective attachment of seed crystals, the same batch of support is coated with the same seed crystals by the same coating procedures, and then the support coated with seed crystal is treated by the ultrasonic waves for 2 minutes and dried. The support is observed by SEM, and the results are shown in FIG. 20. It can be seen from FIG. 20 that most of the seed crystals remain after ultrasonic treatment lasing for 2 minutes.

In this Example, the composite molecular sieve membrane is prepared based on the support layer coated with seed crystal and dried without ultrasonic treatment, and the result of the surface of the composite molecular sieve membrane observed by SEM is shown in FIG. 21, and the result of the section of the molecular sieve membrane observed by SEM is shown in FIG. 22. It can be found that the molecular sieve membrane prepared in the example has a completed and flawless surface, and the thickness of the MFI (silicalite-1) molecular sieve membrane layer is between 2.5 to 4 μm. A SEM image with higher magnification is presented at the top right corner in FIG. 21.

Further, the seed crystals for MFI (silicalite-1) molecular sieve synthesized in this Example, the support layer of Example 2 and the final prepared composite molecular sieve membrane of this Example are analyzed by X-ray diffraction, and the results are shown in FIG. 23, wherein the square “□” refers to the diffraction peaks of MFI (silicalite-1) molecular sieve seed crystals, and the circle “◯” refers to the diffraction peaks of support layer. The result shows that the XRD patterns of the seed crystals comprises all the characteristic diffraction peaks of the MFI (silicalite-1) molecular sieve without any impurity peaks, which can prove that pure MFI (silicalite-1) molecular sieve seed crystals have been obtained. The XRD patterns of the composite molecular sieve membrane comprise all the characteristic diffraction peaks of molecular sieve seed crystals and the characteristic diffraction peak of the support layer, which proves that ideal composite molecular sieve membrane is obtained. SEM-EDX is used for element analysis on the surface of the composite molecular sieve membrane prepared in this Example, and the result is shown in FIG. 24, wherein the Si/Al ratio is nearly positive infinity, the silica-oxygen ratio is nearly 2, and no Al element exists, which corresponds to the anticipation. The corresponding SEM image is presented at the top right corner in FIG. 24.

### Contrast Test 1

The test is carried out the same as Example 6, except that the commercially available α-Al₂O₃ ceramic support is used as the support layer instead.

The sections of the composite molecular sieve membrane prepared in Example 6 and the molecular sieve membrane prepared in this Example are observed by SEM and are analyzed by SEM-EDX, and the results are shown in FIG. 25. As it can be seen, the molecular sieve membrane of this Example has a thickness between 2.8 and 5 μm. The results of the SEM-EDX analysis on the sections shows that aluminum component will escape during the synthesis of pure silica silicalite-1 molecular sieve membrane from the α-Al₂O₃ support, as shown in FIG. 25 (b). The support layer of Example 2 in Example 6 will prevent the escape of aluminum effectively, and ensure the hydrophobicity of pure silica silicalite-1 molecular sieve membrane, as shown in FIG. 25 (a). In the contrast test, the silicalite-1 molecular sieve membrane haven't been calcined to remove the template, wherein the carbon could act as a trace element to indicate the molecular sieve membrane layer, and is used to distinguish the molecular sieve membrane from support layer. The corresponding SEM images of the sections are presented at the right side in FIG. 25(a) and FIG. 25(b).

### Example 7

A molecular sieve membrane is also prepared based on the high-porosity and porous ceramic support layer prepared in EXAMPLE 2, and the molecular sieve membrane is AFI (AlPO₄-5) molecular sieve membrane.

The synthesizing solution containing template of this example comprises 1 part by weight of Al₂O₃, “x” parts by weight of P₂O₅, “y” parts by weight of “R”, and “z” parts by weight of H₂O, wherein x=1-5, y=0.9-2, z=110-400, and R is the template. The template may be triethylamine, tetraethylammonium hydroxide or tetrapropylammonium hydroxide. In the Example, specifically, the synthesizing solution comprises 1 part by weight of Al₂O₃, 1 part by weight of P₂O₅, 1.2 parts by weight of TEAOH, and 55 parts by weight of H₂O.

The test is carried out as following steps: adding 4.652 ml 85% H₃PO₄ and 13.64 g aluminium isopropoxide into 11.26 mL H₂O and stirring them for 5 hours at room temperature; adding 23 mL 25% TEAOH into the mixed solution, and performing an ageing treatment at a temperature of 50° C. for 3 days to obtain the aging solution.

The support layer of the Example 2 and the commercially available Al₂O₃ ceramic support are applied in contrast. The aging solution and two supports are transferred into a hydrothermal reaction kettle and they are placed in the oven to react at a temperature of 200° C. for 24 hours. Then the reaction kettle is taken out to cool down to room temperature. The molecular sieve membranes are taken out and washed with the deionized water, and dried at a temperature of 60° C. to obtain the composite molecular sieve membrane based on the support layer of Example 2 and the one based on the commercially available α-Al₂O₃ ceramic support in contrast.

The surface and the section of the composite molecular sieve membrane based on the support layer of Example 2 are observed by SEM. Meanwhile, the surface and the section of the composite molecular sieve membrane based on the commercially available α-Al₂O₃ ceramic support are also observed by SEM. The results are shown in FIGS. 26-29, wherein FIG. 26 and FIG. 27 show the SEM images of the surface and the section of composite molecular sieve membrane based on the support of Example 2 respectively; FIG. 28 and FIG. 29 show the SEM images of the surface and the section of the composite molecular sieve membrane based on the commercially available α-Al₂O₃ ceramic support respectively. It can be found in FIG. 26 that the molecular sieve membrane based on the support of Example 2 has a particle size of 21×35 μm and has a completed flawless membrane. It can be found in FIG. 27 that the molecular sieve membrane based on the support of Example 2 has a thickness of about 40 μm, and is completed and flawless. It can be found in FIG. 28 that the molecular sieve membrane based on commercially available α-Al₂O₃ ceramic support has sporadically distributed particles, and it is uncontinuous. As shown in FIG. 29, no completed membrane can be found in the sectional image, which further proves that the AFI (AlPO₄-5) molecular sieve membrane cannot be obtained through one in-situ synthesis based on commercially available α-Al₂O₃ ceramic support. The SEM images with higher magnification are presented at their top right corner in FIG. 26 and FIG. 27.

The support of Example 2 and the final composite molecular sieve membrane prepared in the Example are analyzed by X-ray diffraction. The results are shown in FIG. 30, wherein the square “□” refers to the diffraction peaks of AFI (AlPO₄-5) molecular sieve seed crystals, and the circle “◯” refers to the diffraction peaks of support layer. The XRD patterns of composite molecular sieve membrane comprises all characteristic diffraction peaks of AlPO₄-5 molecular sieve without any impurity peaks, which proves that the AFI (AlPO₄-5) molecular sieve membrane can be obtained through one in-situ synthesis based on the support of the Example 2.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1-9. (canceled)

10. A composite molecular sieve membrane, comprising a support layer and a molecular sieve membrane layer, wherein the support layer is a high-porosity and porous ceramic which is made of ceramic powder or ceramic precursor prepared through an electrospinning process; the ceramic powders have particle sizes in a range between 1 nm and 500 nm; the high-porosity and porous ceramic has a porosity of up to 83%, and the porosity is adjustable from 40% to 83%; the porous ceramic has pore sizes in a range between 0.1 and 10 μm, and a pore channel tortuosity of less than 2.

11. The composite molecular sieve membrane according to claim 10, wherein a surface of the support layer is continuous and flat, and the support layer has a thickness between 0.1 and 5 mm.

12. The composite molecular sieve membrane according to claim 10, wherein the ceramic powder is one or more selected from a group consisting of halloysite nanotubes, titanium dioxide, aluminum oxide, zirconium oxide, ferric oxide, yttrium oxide, zinc oxide, silicon carbide, silicon nitride, nickel oxide, manganese oxide, perovskite and uhligite.

13. The composite molecular sieve membrane according to claim 10, wherein a continuously distributed membrane layer is formed on the surface of the support, through at least one of the methods of secondary growth, in-situ hydrothermal synthesis and vapor-phase transport.

14. The composite molecular sieve membrane according to claim 11, wherein a continuously distributed membrane layer is formed on the surface of the support, through at least one of the methods of secondary growth, in-situ hydrothermal synthesis and vapor-phase transport.

15. The composite molecular sieve membrane according to claim 12, wherein a continuously distributed membrane layer is formed on the surface of the support, through at least one of the methods of secondary growth, in-situ hydrothermal synthesis and vapor-phase transport.

16. Methods for performing membrane separation and preparing sensors, biomedicine, antirot materials, dielectric materials and microreactors, comprising steps of:
preparing a composite molecular sieve membrane according to claim 10;
applying the composite molecular sieve membrane to perform membrane separation and prepare sensors, biomedicine, antirot materials, dielectric materials and microreactors.

17. A preparation method of the composite molecular sieve membrane according to claim 10, comprising follow steps:
(1) dispersing the nano- or submicron ceramic powder material or ceramic material precursor in a solvent, then adding a polymer and stirring them evenly to obtain a spinning solution used for electrospinning process;
(2) applying an electrospinning method to obtain a ceramic material/polymer composite fiber membrane with the spinning solution;
(3) pretreating the ceramic material/polymer composite fiber membrane, and press-forming it afterwards;
(4) sintering the press-formed composite fiber membrane to remove the polymer, whereby a support layer is prepared;
(5) applying at least one of the methods of the secondary growth, in-situ hydrothermal synthesis and vapor-phase transport to form a continuously distributed molecular sieve membrane layer on the surface of the support layer, whereby a composite molecular sieve membrane is prepared;
wherein the polymer is at least one selected from a group consisting of polystyrene, polyacrylonitrile, polyvinylpyrrolidone, poly(lactic-co-glycolic acid), polyvinyl alcohol, polyethylene oxide, polyamide, polyvinylidene fluoride, polyvinyl butyral, polyimide, cellulose acetate, polymethyl methacrylate, poly(L-lactic acid) and polyethylene terephthalate; the polymer has a molecular weight in a range between 0.1 million to 0.5 million;
the preptreating comprises a pre-oxidization under 70-280° C. in the air circumstance for less than 48 hours.

18. The preparation method according to claim 17, wherein a weight ratio of the solvent and polymer is from 4:1 to 19:1; and a weight ratio of ceramic powder material or ceramic material precursor and polymer is between 1:10 to 1:0.

19. The preparation method according to claim 17, wherein a silicon/aluminum ratio of the molecular membrane layer is in a range from 1 to infinity, or the molecular membrane layer is heteroatom-substituted, and the heteroatom-substituted molecular sieve comprises, SAPO-34, AlPO-18 or TS-1.

20. The preparation method according to claim 17, wherein the solvent in step (1) is at least one selected from a group consisting of water, tetrahydrofuran, N,N-dimethylformamide, N,N-dimethylacetamide, acetone, ethanol, methanol.

21. The preparation method according to claim 18, wherein a silicon/aluminum ratio of the molecular membrane layer is in a range from 1 to infinity, or the molecular membrane layer is heteroatom-substituted, and the heteroatom-substituted molecular sieve comprises, SAPO-34, AlPO-18 or TS-1.

22. The preparation method according to claim 18, wherein the solvent in step (1) is at least one selected from a group consisting of water, tetrahydrofuran, N,N-dimethylformamide, N,N-dimethylacetamide, acetone, ethanol, and methanol.

23. A preparation method of the composite molecular sieve membrane according to claim 11, comprising follow steps:
(1) dispersing the nano- or submicron ceramic powder material or ceramic material precursor in a solvent, then adding a polymer and stirring them evenly to obtain a spinning solution used for electrospinning process;
(2) applying an electrospinning method to obtain a ceramic material/polymer composite fiber membrane with the spinning solution;
(3) pretreating the ceramic material/polymer composite fiber membrane, and press-forming it afterwards;
(4) sintering the press-formed composite fiber membrane to remove the polymer, whereby a support layer is prepared;
(5) applying at least one of the methods of the secondary growth, in-situ hydrothermal synthesis and vapor-phase transport to form a continuously distributed molecular sieve membrane layer on the surface of the support layer, whereby a composite molecular sieve membrane is prepared;
wherein the polymer is at least one selected from a group consisting of polystyrene, polyacrylonitrile, polyvinylpyrrolidone, poly(lactic-co-glycolic acid), polyvinyl alcohol, polyethylene oxide, polyamide, polyvinylidene fluoride, polyvinyl butyral, polyimide, cellulose acetate, polymethyl methacrylate, poly(L-lactic acid) and polyethylene terephthalate; the polymer has a molecular weight in a range between 0.1 million to 0.5 million;
the preptreating comprises a pre-oxidization under 70-280° C. in the air circumstance for less than 48 hours.

24. The preparation method according to claim 23, wherein a weight ratio of the solvent and polymer is from 4:1 to 19:1; and a weight ratio of ceramic powder material or ceramic material precursor and polymer is between 1:10 to 1:0.

25. The preparation method according to claim 23, wherein a silicon/aluminum ratio of the molecular membrane layer is in a range from 1 to infinity, or the molecular membrane layer is heteroatom-substituted, and the heteroatom-substituted molecular sieve comprises, SAPO-34, AlPO-18 or TS-1.

26. The preparation method according to claim 23, wherein the solvent in step (1) is at least one selected from a group consisting of water, tetrahydrofuran, N,N-dimethylformamide, N,N-dimethylacetamide, acetone, ethanol, methanol.

27. The preparation method according to claim 24, wherein a silicon/aluminum ratio of the molecular membrane layer is in a range from 1 to infinity, or the molecular membrane layer is heteroatom-substituted, and the heteroatom-substituted molecular sieve comprises, SAPO-34, AlPO-18 or TS-1.

28. The preparation method according to claim 24, wherein the solvent in step (1) is at least one selected from a group consisting of water, tetrahydrofuran, N,N-dimethylformamide, N,N-dimethylacetamide, acetone, ethanol, and methanol.

29. A preparation method of the composite molecular sieve membrane according to claim 12, comprising follow steps:
(1) dispersing the nano- or submicron ceramic powder material or ceramic material precursor in a solvent, then adding a polymer and stirring them evenly to obtain a spinning solution used for electrospinning process;
(2) applying an electrospinning method to obtain a ceramic material/polymer composite fiber membrane with the spinning solution;
(3) pretreating the ceramic material/polymer composite fiber membrane, and press-forming it afterwards;
(4) sintering the press-formed composite fiber membrane to remove the polymer, whereby a support layer is prepared;
(5) applying at least one of the methods of the secondary growth, in-situ hydrothermal synthesis and vapor-phase transport to form a continuously distributed molecular sieve membrane layer on the surface of the support layer, whereby a composite molecular sieve membrane is prepared;
wherein the polymer is at least one selected from a group consisting of polystyrene, polyacrylonitrile, polyvinylpyrrolidone, poly(lactic-co-glycolic acid), polyvinyl alcohol, polyethylene oxide, polyamide, polyvinylidene fluoride, polyvinyl butyral, polyimide, cellulose acetate, polymethyl methacrylate, poly(L-lactic acid) and polyethylene terephthalate; the polymer has a molecular weight in a range between 0.1 million to 0.5 million;
the preptreating comprises a pre-oxidization under 70-280° C. in the air circumstance for less than 48 hours.
